(19) United States
(12) Patent Application Publication
(10) Pub. No.: US 2024/0070400 A1
(43) Pub. Date: Feb. 29, 2024

(54) METHOD OF ANALYSIS TEXT MESSAGE SYNTACTICALLY AND BY CONTENT

(71) Applicant: VIETTEL GROUP, Ha Noi City (VN)

(72) Inventors: Van Chung Trinh, Ha Noi City (VN); Duc Hai Nguyen, Tien Du District (VN); Dinh Hung Nguyen, Thanh Liem District (VN); Hai Son Bui, Ha Noi City (VN); Duc Anh Nguyen, Ha Noi City (VN); Thi Huyen Trang Nguyen, Thanh Hoa City (VN); Thi Thuy Linh Le, Yen Lac District (VN); Van Chinh Pham, Nam Truc district (VN); Van Manh Phan, Ha Noi City (VN)

(73) Assignee: VIETTEL GROUP, Ha Noi City (VN)

(21) Appl. No.: 18/458,546

(22) Filed: Aug. 30, 2023

(30) Foreign Application Priority Data
Aug. 31, 2022 (VN) 1-2022-05573

(51) Int. Cl. G06F 40/35; G06F 40/284

(52) U.S. Cl. CPC G06F 40/35; G06F 40/284

(57) ABSTRACT

Method of analysis text message syntactically and by content, which entails: step 1; Split syntaxes (made available to subscribers by the network operator) into tokens to store in a Syntax Trie; step 2. Pre-process an incoming text from a subscriber; step 3. Split the text (pre-processed in Step 2) into tokens; step 4. Look up paths that include the tokens (obtained in Step 3) in the Syntax Trie (initialized in Step 1); step 5: Return the look-up result, which is the path in the Syntax Trie that best reflects the user intent.

### TECHNICAL FIELD COVERED

This patent covers a method of determining the user intent based on a text message's syntax. In particular, the method analyzes the message's keyword and specifier(s) to deduce which interaction is requested by the subscriber.

### TECHNICAL STATUS OF THE INVENTION

A telecom system typically provides the subscribers with a range of self-service interactions such as checking balances, changing plans, and terminating services. The network operator may make these interactions available to their subscribers via SMS. When a subscriber sends a text message containing a specific syntax to the telecom system, the system analyzes the syntax to infer what the subscriber wants and responds accordingly. The analysis comprises these following steps:
Step 1: The network operator inputs syntaxes in the system and assigns a business process to each of the syntaxes.
Step 2: The system awaits incoming messages from the subscribers and pre-processes the messages should they arrive.
Step 3: For each of the pre-processed messages, the system checks if the syntax is valid and performs the business process attached to that syntax.

Each of these three steps demands a certain level of technological complexity. The data model to implement syntaxes must be flexible, while the syntax look-up and retrieval must be done with high accuracy and in minimal time. There has not been a method to satisfy these technological requirements sufficiently. To address this problem, this patent proposes a method of determining the user intent based on a text message's syntax.

### TECHNICAL NATURE OF THE INVENTION

To address the aforementioned complexity and limitations, this patent proposes a method of determining the user intent based on a text message's syntax, which entails the following steps:
Step 1: Split syntaxes (made available to subscribers by the network operator) into Tokens and Store the Tokens in a Trie.
   The network operator may offer their subscribers a range of special SMS syntaxes that they can use to interact with the telecom system (e.g. to check balances, update plans, or cancel services). Each syntax is composed of one mandatory keyword and zero, one, or multiple specifiers, depending on a particular syntax. Each message from the subscribers must contain exactly one keyword. The number of specifiers following the keyword may be 0, 1, 2, or more, depending on the particular syntax associated with a specific user intent.
Step 2: Pre-process an incoming text from a subscriber
   This process normalizes and standardizes incoming texts from the subscribers. Some possible mistakes a subscriber can make in his or her texts are: leading and trailing space characters or extra space characters (two or more) between tokens. Upon receiving a text message from a subscriber, the telecom system removes all leading and trailing space characters in the message, deletes extra space characters between tokens, and converts all the characters to upper-case (if applicable).
Step 3: Split the pre-processed text into tokens
   The telecom system splits the pre-processed text (obtained from Step 2) into tokens, based on the space characters. The tokens are then appended to an ordered list data structure, in the order of left to right in the pre-processed text. Thus, in the ordered list, left tokens come before right tokens.
Step 4: Look up the tokens in the syntax trie
   The telecom system looks up each token in the ordered list (obtained from Step 3). FIG. 4 outlines the look-up process. First, the system searches for the first token in the first layer of the Syntax Trie, which contains root nodes. Once the system has found a match, it continues to look for the second token among the children of that matching root node. If the system finds a root node's child that matches the second token, it continues to look for the third token among the children of that root node's child. The process repeats until the telecom system has reached a leaf node. At the end of this step, the telecom system collects a set of potential paths. Each path is a sequence of nodes that represents the ordered list of the tokens; each path starts at the root node and ends at a leaf node.
Step 5: Return the look-up result
   The telecom system selects the most relevant path in the set generated by Step 4. This path best reflects the user intent.

### BRIEF DESCRIPTION OF THE DRAWINGS

FIG. 1 outlines the method of determining the user intent based on a text message's syntax;

FIG. 2 delineates the Syntax Trie—a trie that encapsulates syntaxes by storing keywords and specifiers as nodes;

FIG. 3 illustrates the process of splitting a subscriber's text into tokens; and

FIG. 4 depicts the look-up process that a telecom system employs to determine the user intent.

### DETAILED DESCRIPTION OF THE INVENTION

The invention detailed below utilizes supplementary drawings that aim to elucidate the description. These drawings are mere suggestions and do not necessarily limit the scope of the patent.

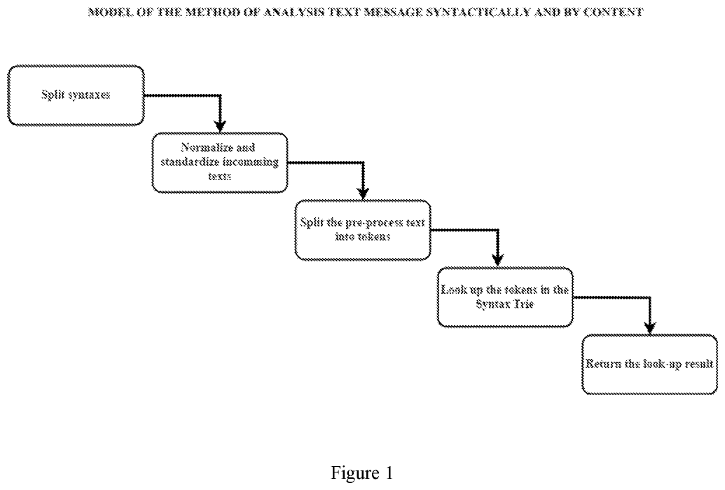

The patent proposes a method of determining the user intent based on a text message's syntax (refer to FIG. 1). The method involves these following steps:
Step 1: Split syntaxes (made available to subscribers by the network operator) into tokens and store the tokens in a trie.

The network operator may offer their subscribers a range of special SMS syntaxes that they can use to interact with the telecom system (e.g. to check balances, update plans, or cancel services). Each syntax is composed of one mandatory keyword and zero, one, or multiple specifiers, depending on a particular syntax. A syntax takes the following form:
KEYWORD SPECIFIER_1 SPECIFIER_2 SPECIFIER_3 . . .

For example, a subscriber can sign up for plan A to use in 30 days by sending the following text:
SIGNUP A 30 DAY
where SIGNUP is the keyword,
   A is the first specifier,
   30 is the second specifier,
   DA Y in the third specifier.
      If the subscriber wants to sign up for plan A without specifying a termination date, he or she can send the following text:
SIGNUP A
where SIGNUP is the keyword,
   A is the first and only specifier.
      Each message sent from the subscribers must contain exactly one keyword. The number of specifiers following the keyword may be 0, 1, 2, or more, depending on the particular syntax associated with a specific user intent.

The telecom system processes syntaxes inputted by a network operator and stores them into two databases, whose schemas are detailed in Table 1 and Table 2. Table 1 describes the schema of the table that contains all the available keywords. Table 2 describes the schema of the table that contains all the specifiers that accompany each of the keywords.

TABLE 1
KEYWORDS

| Field Name | Data Type | Description |
|---|---|---|
| KEYWORD_ID | Integer | ID number of a keyword (also the |
| | | primary key of this table) |
| KEYWORD | String | Keyword, or the first token, in a syntax |

TABLE 2
SPECIFIERS

| Field Name | Data Type | Description |
|---|---|---|
| SPECIFIER_ID | Integer | ID number of a specifier (also the |
| | | primary key of this table) |
| KEYWORD_ID | Integer | ID number of the keyword that |
| | | precedes the specifier |
| SPECIFIER | String | Human-readable description of the |
| | | specifier |
| ORDER_IN_SYNTAX | Integer | Describe the location of specifier |
| | | in the message |

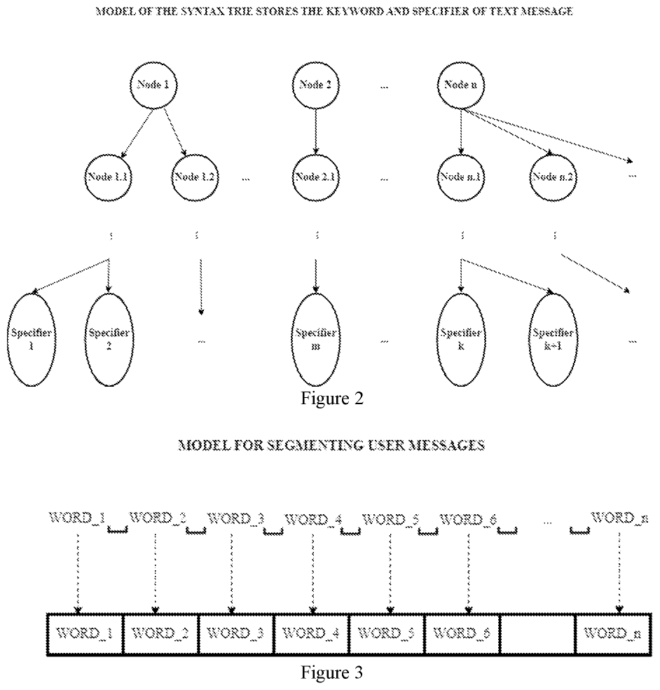

To build the Syntax Trie, the telecom system reads from the two tables. FIG. 2 is an example of a Syntax Trie, which consists:
Root nodes: nodes at the first level of the trie (i.e. they have no parent), representing keywords in syntaxes
Leaf nodes: nodes at the last level of the trie (i.e. they have no child node), representing the specifiers
Intermediate nodes: nodes in-between the roots and the leaves. Intermediate nodes serve as the storage for words in the syntax of configuration messages starting from the position of the second word to the end of configuration messages. Each word is a node, and these words are arranged as node from top to bottom in the order from left to right of the words in the syntax.
Step 2: Pre-process an incoming text from a subscriber

This process normalizes and standardizes incoming texts from subscribers. Some potential mistakes subscribers can make in their texts are leading and trailing space characters, and extra space characters (two or more) between tokens. Upon receiving a text message from a subscriber, the telecom system removes all the leading and trailing space characters in the message, replaces all repeated space characters with only one space character, and finally converts all characters into upper-case (if applicable)
Step 3: Split the text (pre-processed in Step 2) into tokens

The telecom system splits the pre-processed text (obtained from Step 2) into tokens, based on the space characters. FIG. 3 portrays the splitting process. The tokens are added into an ordered list data structure, in the order of left to right in the pre-processed text. Thus, in the ordered list, left tokens come before right tokens.
Step 4: Look up the tokens in the syntax trie

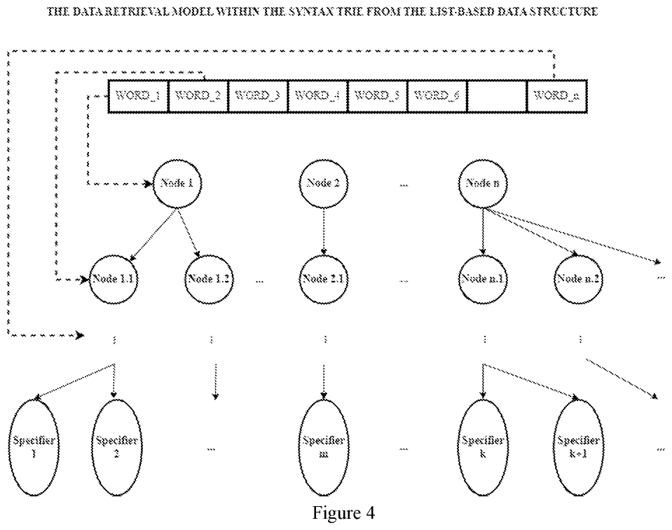

The telecom system looks up each token in the ordered list (obtained from Step 3). FIG. 4 summarizes the look-up process. First, the system searches for the first token in the first layer of the Syntax Trie, which contains root nodes. Once the system has found a match, it continues to look for the second token among the children of that matching root node. If the system finds a root node's child that matches the second token, it continues to look for the third token among the children of that root node's child. The process repeats until the telecom system has reached a leaf node. At the end of this step, the telecom system collects a set of potential paths. Each path is a sequence of nodes that represents the ordered list of the tokens; each path starts at the root node and ends at a leaf node.

When the look-up has been completed, the system returns a set of potential paths. If the set is empty, the system cannot determine the user intent and thus does nothing. If the set has exactly one member, meaning there is exactly one path that conveys the user intent, the system performs the associated business process. If the set has two or more members, the system selects the shortest path (i.e. with the fewest nodes) as the one that best conveys the user intent and then performs the business process assigned to this path.
Step 5: Return the look-up result

The telecom system selects the most relevant path in the set generated by
Step 4. This path best reflects the user intent.

### Efficacy of the Invention

This patent defines a method of determining the user intent based on a text message's syntax. This specific method was developed with two main objectives in mind:
The first objective is to enhance the accuracy in determining user intent conveyed in a message sent from a subscriber
The second objective is to minimize the look-up time so that the response time is kept within milliseconds, which is crucial in maintaining the quality of user experience
   Technical details in the description above are not prescriptive. They do not impose strict limitations on the deployment of this method, but rather are suggestions included for the sake of clarity.

1. Method of analysis text message syntactically and by content, which includes:
Step 1: Split syntaxes (made available to subscribers by the network operator) into tokens and store the tokens in a trie,
each syntax is composed of one mandatory keyword and zero, one, or multiple specifiers, depending on a particular syntax, the keyword is always the first token in a syntax, and the specifiers, if any, come after;
the network operator inputs the syntaxes in the telecom system in the form of tokens delimited by space characters, the tokens are then organized into a trie, called the Syntax Trie, each node in a first level of the trie contains a keyword and thus is called a keyword node, if a syntax necessitates specifiers, each of the specifier would be a node in the subtree rooting at the keyword node, in particular, from left to right, the first specifier in the syntax would be an immediate child node of the keyword node, the second specifier would be an immediate child node of the node representing the first leftmost specifier, in this fashion, the syntax is represented by a path of nodes in the Syntax Trie, starting at the keyword node and ending at the node representing the last specifier, the Syntax Trie is used to determine the user intent conveyed in future incoming messages from the subscribers;
Step 2: Pre-process an incoming text from a subscriber
upon receiving a text message from a subscriber, the telecom system removes all the leading and trailing space characters in the message, replaces all repeated space characters with only one space character, and finally converts all characters into upper-case (if applicable);
Step 3: Split the text (pre-processed in Step 2) into tokens
the telecom system splits the pre-processed text (obtained from Step 2) into tokens, based on the space characters, the tokens are added into an ordered list data structure, in the order of left to right in the pre-processed text, thus, in the ordered list, left tokens come before right tokens;
Step 4: look up paths that include the tokens (obtained in Step 3) in the Syntax Trie (initialized in Step 1)
the telecom system looks up each token in the ordered list (obtained from Step 3), first, the system searches for the first token in the first layer of the Syntax Trie, which contains root nodes, once the system has found a match, it continues to look for the second token among the children of that matching root node, if the system finds a root node's child that matches the second token, it continues to look for the third token among the children of that root node's child, the process repeats until the telecom system has reached a leaf node, at the end of this step, the telecom system collects a set of potential paths, each path is a sequence of nodes that represents the ordered list of the tokens; each path starts at the root node and ends at a leaf node;
Step 5: return the look-up result
the telecom system selects the most relevant path in the set generated by Step 4, this path best reflects the user intent.

2. The method according to claim 1, wherein a syntax takes the form:
KEYWORD SPECIFIER_1 SPECIFIER_2 SPECIFIER_3.

3. The method according to claim 1, wherein the database that stores syntaxes employs the following schema:
TABLE 1
KEYWORDS

| Field Name | Data Type | Description |
|---|---|---|
| KEYWORD_ID | Integer | ID number of a keyword (also the |
| | | primary key of this table) |
| KEYWORD | String | Keyword, or the first token, in a syntax |

TABLE 2
SPECIFIERS

| Field Name | Data Type | Description |
|---|---|---|
| SPECIFIER_ID | Integer | ID number of a specifier (also the |
| | | primary key of this table) |
| KEYWORD_ID | Integer | ID number of the keyword that |
| | | precedes the specifier |
| SPECIFIER | String | Human-readable description of the |
| | | specifier |
| ORDER_IN_SYNTAX | Integer | Describe the location of specifier |
| | | in the message. |

4. The method according to claim 2, wherein the database that stores syntaxes employs the following schema:
TABLE 1
KEYWORDS

| Field Name | Data Type | Description |
|---|---|---|
| KEYWORD_ID | Integer | ID number of a keyword (also the |
| | | primary key of this table) |
| KEYWORD | String | Keyword, or the first token, in a syntax |

TABLE 2
SPECIFIERS

| Field Name | Data Type | Description |
|---|---|---|
| SPECIFIER_ID | Integer | ID number of a specifier (also the |
| | | primary key of this table) |
| KEYWORD_ID | Integer | ID number of the keyword that |
| | | precedes the specifier |
| SPECIFIER | String | Human-readable description of the |
| | | specifier |
| ORDER_IN_SYNTAX | Integer | Describe the location of specifier |
| | | in the message. |

5. The method according to claim 1, wherein the configuration reading subsystem (loadconfig process) accesses the database using a protocol to interact with the database supported by the programming language, it reads two tables: keywords table and specifiers table, the data read from these tables will be utilized to construct the Syntax Trie.

6. The method according to claim 2, wherein the configuration reading subsystem (loadconfig process) accesses the database using a protocol to interact with the database supported by the programming language, it reads two tables: keywords table and specifiers table, the data read from these tables will be utilized to construct the Syntax Trie.

7. The method according to claim 3, wherein the configuration reading subsystem (loadconfig process) accesses the database using a protocol to interact with the database supported by the programming language, it reads two tables: keywords table and specifiers table, the data read from these tables will be utilized to construct the Syntax Trie.

8. The method according to claim 1, wherein the Syntax Trie contains the following components:
Root nodes: nodes at the first level of the trie (i.e. they have no parent), representing keywords in syntaxes
Leaf nodes: nodes at the last level of the trie (i.e. they have no child node), representing the specifiers
Intermediate nodes: nodes in-between the roots and the leaves. Intermediate nodes serve as the storage for words in the syntax of configuration messages starting from the position of the second word to the end of configuration messages, each word is a node, and these words are arranged as node from top to bottom in the order from left to right of the words in the syntax.

9. The method according to claim 2, wherein the Syntax Trie contains the following components:
Root nodes: nodes at the first level of the trie (i.e. they have no parent), representing keywords in syntaxes
Leaf nodes: nodes at the last level of the trie (i.e. they have no child node), representing the specifiers
Intermediate nodes: nodes in-between the roots and the leaves. Intermediate nodes serve as the storage for words in the syntax of configuration messages starting from the position of the second word to the end of configuration messages, each word is a node, and these words are arranged as node from top to bottom in the order from left to right of the words in the syntax.

10. The method according to claim 3, wherein the Syntax Trie contains the following components:
Root nodes: nodes at the first level of the trie (i.e. they have no parent), representing keywords in syntaxes
Leaf nodes: nodes at the last level of the trie (i.e. they have no child node), representing the specifiers
Intermediate nodes: nodes in-between the roots and the leaves. Intermediate nodes serve as the storage for words in the syntax of configuration messages starting from the position of the second word to the end of configuration messages, each word is a node, and these words are arranged as node from top to bottom in the order from left to right of the words in the syntax.

11. The method according to claim 5, wherein the Syntax Trie contains the following components:
Root nodes: nodes at the first level of the trie (i.e. they have no parent), representing keywords in syntaxes
Leaf nodes: nodes at the last level of the trie (i.e. they have no child node), representing the specifiers
Intermediate nodes: nodes in-between the roots and the leaves. Intermediate nodes serve as the storage for words in the syntax of configuration messages starting from the position of the second word to the end of configuration messages, each word is a node, and these words are arranged as node from top to bottom in the order from left to right of the words in the syntax.

12. The method according to claim 1, wherein the system's response in Step 5 depends on the size of the set of potential paths:
when the look-up has been completed, the system returns a set of potential paths, if the set is empty, the system cannot determine the user intent and thus does nothing, if the set has exactly one member, meaning there is exactly one path that conveys the user intent, the system performs the associated business process, if the set has two or more members, the system performs additional processing to select the path that best conveys the user intent and then performs the business process assigned to this path.

13. The method according to claim 2, wherein the system's response in Step 5 depends on the size of the set of potential paths:
when the look-up has been completed, the system returns a set of potential paths, if the set is empty, the system cannot determine the user intent and thus does nothing, if the set has exactly one member, meaning there is exactly one path that conveys the user intent, the system performs the associated business process, if the set has two or more members, the system performs additional processing to select the path that best conveys the user intent and then performs the business process assigned to this path.

14. The method according to claim 3, wherein the system's response in Step 5 depends on the size of the set of potential paths:
when the look-up has been completed, the system returns a set of potential paths, if the set is empty, the system cannot determine the user intent and thus does nothing, if the set has exactly one member, meaning there is exactly one path that conveys the user intent, the system performs the associated business process, if the set has two or more members, the system performs additional processing to select the path that best conveys the user intent and then performs the business process assigned to this path.

15. The method according to claim 5, wherein the system's response in Step 5 depends on the size of the set of potential paths:
when the look-up has been completed, the system returns a set of potential paths, if the set is empty, the system cannot determine the user intent and thus does nothing, if the set has exactly one member, meaning there is exactly one path that conveys the user intent, the system performs the associated business process, if the set has two or more members, the system performs additional processing to select the path that best conveys the user intent and then performs the business process assigned to this path.

16. The method according to claim 8, wherein the system's response in Step 5 depends on the size of the set of potential paths:
when the look-up has been completed, the system returns a set of potential paths, if the set is empty, the system cannot determine the user intent and thus does nothing, if the set has exactly one member, meaning there is exactly one path that conveys the user intent, the system performs the associated business process, if the set has two or more members, the system performs additional processing to select the path that best conveys the user intent and then performs the business process assigned to this path.

17. The method according to claim 1, wherein the process of selecting the best path in Step 5 is done as follows:
in a set of two or more potential paths, the system sorts the paths based on the number of nodes included in each path, the path with the fewest nodes best reflects the user intent, consequently, the telecom system performs the business process attached to that path.

18. The method according to claim 2, wherein the process of selecting the best path in Step 5 is done as follows:
in a set of two or more potential paths, the system sorts the paths based on the number of nodes included in each path, the path with the fewest nodes best reflects the user intent, consequently, the telecom system performs the business process attached to that path.

19. The method according to claim 3, wherein the process of selecting the best path in Step 5 is done as follows:
in a set of two or more potential paths, the system sorts the paths based on the number of nodes included in each path, the path with the fewest nodes best reflects the user intent, consequently, the telecom system performs the business process attached to that path.

20. The method according to claim 5, wherein the process of selecting the best path in Step 5 is done as follows:
in a set of two or more potential paths, the system sorts the paths based on the number of nodes included in each path, the path with the fewest nodes best reflects the user intent, consequently, the telecom system performs the business process attached to that path.
